(19) United States
(12) Patent Application Publication
(10) Pub. No.: US 2009/0296943 A1
(43) Pub. Date: Dec. 3, 2009

(54) REPRODUCTION OF LOW FREQUENCY EFFECTS IN SOUND REPRODUCTION SYSTEMS

(75) Inventor: Geoffrey Glen Martin, Vinderup (DK)

Correspondence Address: STITES & HARBISON PLLC, 1199 NORTH FAIRFAX STREET, SUITE 900, ALEXANDRIA, VA, 22314, US

(73) Assignee: BANG & OLUFSEN A/S, Struer (DK)

(21) Appl. No.: 11/721,700

(22) PCT Filed: Dec. 8, 2005
(86) PCT No.: PCT/IB2005/054121

§ 371 Date: Jul. 8, 2009

(30) Foreign Application Priority Data
Dec. 14, 2004 (DK) PA 2004 01926

(51) Int. Cl. H04R 5/00

(52) U.S. Cl. 381/17

(57) ABSTRACT

The invention relates to a method and system for reproduction of sound signals con-tained in a low frequency effect (LFE) channel in an audio reproduction system com-prising at least one main loudspeaker—although typically either five main loudspeakers in a surround sound system or two main loudspeakers in a traditional stereophonic system—and at least one low frequency loudspeaker (subwoofer) for reproduction of the lowest portion of the audible frequency range. According to the method and system of the present invention, the frequency range or the LFE channel is subdivided into a first frequency region below a given cutoff frequency, which first frequency region is provided to the subwoofer, and a second frequency region above said cut-off frequency, which second frequency region is provided to at least one of the main loudspeakers.

### TECHNICAL FIELD

The invention relates generally to sound reproduction systems and methods and specifically to the reproduction of low frequency signal components recorded in a Low Frequency Effects (LFE) channel

### BACKGROUND OF THE INVENTION

Existing bass management systems assume that the playback system consists of two or more “main” loudspeakers that are incapable of reproducing extremely low frequency content in the program material. Consequently, the signals are divided into low frequency and high frequency components using a crossover network. The high frequency components are produced by the main loudspeakers. The corresponding low frequency components are summed with each other and with a Low Frequency Effects (LFE) channel (where applicable) and directed to a dedicated low-frequency loudspeaker termed a “subwoofer”. Typical examples of prior art systems for 5.1-channel program material are shown in FIGS. 1a and 1b.

FIGS. 1a and 1b show individual crossover networks for each of the five full-bandwidth channels with the low frequency output of each routed to a summing bus. In addition, the LFE channel is typically boosted by 10 dB and added to the same bus. This combined signal is then routed to the subwoofer's amplifier. In cases where the five main loudspeakers have matched characteristics, the crossover characteristics will also be matched from channel to channel. However, in cases where the main loudspeakers are not matched (for example, when the surround loudspeakers have reduced bass handling potential), the crossover characteristics for each channel can be tailored to the requirements of the corresponding loudspeaker(s).

There is a potential flaw in standard bass management systems caused by a mis-match between the allowable bandwidth of the LFE channel and the capabilities of the subwoofer used to produce this signal. The proposed system outlines a possible solution for correcting this problem.

Standard practice for content in the LFE channel in distribution media has dictated an upper frequency maximum limitation of 120 Hz. As can be seen in FIG. 1, a conventional bass management system sums the low frequency content of the main channels with this LFE signal and delivers this combined signal to the subwoofer. However, whereas this system compensates for deficiencies in the main loudspeakers, it makes assumptions concerning the capabilities of the subwoofer. Specifically, it is assumed that the subwoofer is capable of producing signals up to and including 120 Hz with adequate sound quality. In situations where this is not the case—where the subwoofer has an upper cut-off frequency lower than 120 Hz, for example—the upper frequency range of the LFE channel is not properly reproduced.

### DISCLOSURE OF THE INVENTION

On the above background it is an object of the present invention to provide a method and corresponding system for solving the problems mentioned above originating from the subwoofer's insufficient capability for handling the reproduction of frequency components above the subwoofer's upper cut-off frequency.

According to the invention, this object is attained by directing the upper frequency components of the LFE channels to the main loudspeakers with appropriate compensation in order to ensure that these components are correctly reproduced, regardless of the subwooferes capabilities.

According to the present invention, the above object is thus attained by a method for the reproduction of sound signals of an LFE channel in a loudspeaker system comprising at least one main loudspeaker and at least one low frequency loudspeaker (subwoofer), the method being characterised in that a first frequency region of the sound signals contained in the LFE channel below a given upper cut-off frequency is reproduced by the subwoofer, and a second frequency region of the sound signals contained in the LFE channel above a given upper cut-off frequency is reproduced by at least one of said main loudspeakers.

The present invention furthermore relates to a system for the reproduction of sound signals of a LFE channel in a loudspeaker system comprising at least one main loudspeaker and at least one low frequency loudspeaker (subwoofer), said system being provided with filter means for subdividing the frequency content of the LFE channel into a first frequency region below a given upper cut-off frequency and a second frequency region above this cut-off frequency, and further providing said first frequency region to the subwoofer and said second frequency region to at least one of said main loudspeakers

Two specific embodiments of systems according to the invention are described in the detailed description of the invention, but it is understood that other embodiments of the method and system according to the invention can be implemented, and that such other embodiments would also fall within the scope of the present invention as defined by the appended independent claims. Specifically the present invention is exemplified with reference to surround sound systems comprising five main loudspeakers (centre front, front left, front right, rear left and rear right) and an additional subwoofer, but the method and system according to the invention are not limited to systems comprising five main loudspeakers. The method according to the invention may be applied to audio reproduction systems comprising any number of channels provided that at least one LFE channel is present.

Typical applications of the method and system according to the invention that can be envisaged would be applications within domestic audio reproduction systems, such as traditional surround sound systems, and also within automotive audio reproduction systems, but these applications are of course only to be regarded as typical fields of applications.

The main advantages of the method and system according to the invention are the reduced requirements imposed on the subwoofer loudspeaker as well as an improved reproduction of the LFE channel.

### BRIEF DESCRIPTION OF THE DRAWINGS

The method and system according to the present invention will be better understood with reference to the following detailed description of two embodiments of the system in conjunction with the drawings, in which

FIG. 1a shows a schematic block diagram of a prior art implementation of a bass management system for a 5.1-channel media comprising five main loudspeakers (including one left and one right surround loudspeaker) and a subwoofer;

FIG. 1b shows a schematic block diagram of a prior art implementation of a bass management system for a 5.1-channel media comprising nine main loudspeakers (including three left and three right surround sound loudspeakers) and a subwoofer;

FIG. 2 shows a schematic block diagram of a first embodiment of the LFE management system according to the present invention using five matched main loudspeakers, each of which receives a scaled version of the signal in the LFE channel;

FIG. 3 shows a schematic block diagram of a second embodiment of the LFE management system according to the present invention in a configuration where only the left and right front loudspeakers receive a scaled version of the signal in the LFE channel; and

FIG. 4 shows a schematic block diagram of a third embodiment of the LFE management system according to the present invention in a configuration where only the left and right surround loudspeakers receive a scaled version of the signal in the LFE channel.

### DETAILED DESCRIPTION OF THE INVENTION

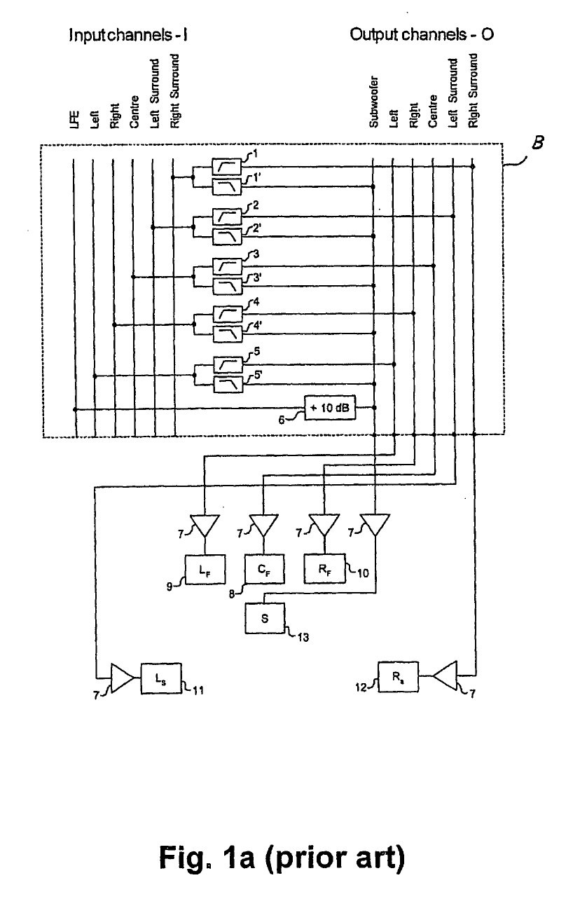

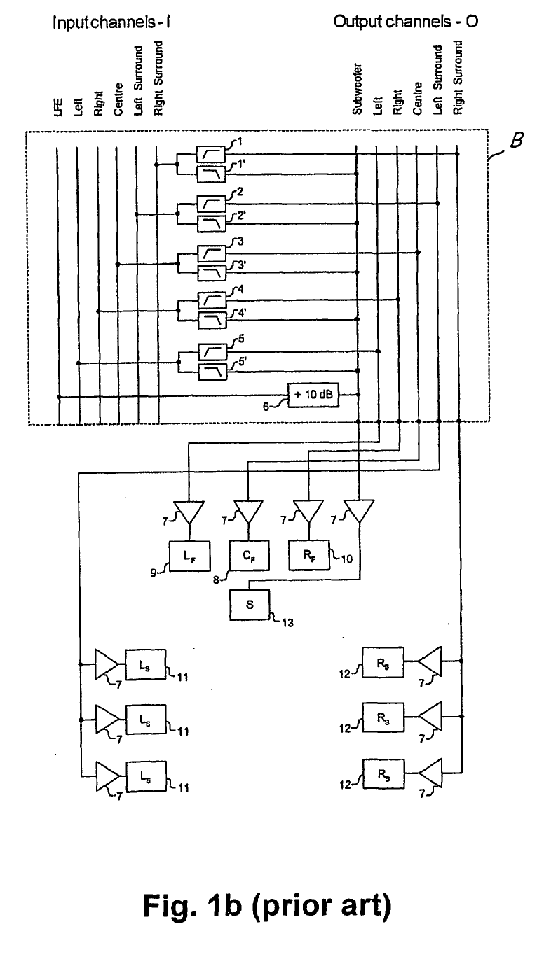

Referring to FIG. 1a, there is shown a first example of a prior art surround sound reproduction system comprising five main loudspeakers 8, 9, 10, 11 and 12, each driven by its own power amplifier 7. As is well known, the main loudspeakers comprise a centre loudspeaker, left and right front loudspeakers, and left and right surround loudspeakers typically located to the left and right behind the listening region. The system furthermore comprises a low frequency loudspeaker 13 (“subwoofer”) for reproduction of the extremely low frequencies.

The system furthermore comprises a prior art bass management system B comprising five crossover networks 1, 1′; 2, 2′; 3, 3′; 4, 4′; 5, 5′ containing high pass filter blocks for provision of signals to the main loudspeakers and corresponding low pass filter blocks for provision of low frequency signals to the subwoofer 13. The signal in the LFE channel is provided solely to the subwoofer 13 after a boost of typically 10 dB, as mentioned above. Thus, the frequency components of the LFE channel are only reproduced by the subwoofer 13.

Referring to FIG. 1b, there is shown an alternative prior art implementation of a bass management system B for a 5.1-channel media where the two surround loudspeakers 11, 12 in FIG. 1 have been replaced by three left surround loudspeakers 11 and three right surround loudspeakers 12. The embodiment shown in FIG. 1b is mainly used in larger systems, where multiple loudspeakers are used for a single surround channel to provide better coverage of a large listening room, for instance in a cinema. Multiple surround loudspeakers could also be used to increase the power handling capacity, for instance at low frequencies, of the surround loudspeakers, for instance in order to increase the ability of these loudspeakers to reproduce powerful low frequency components in the surround channels.

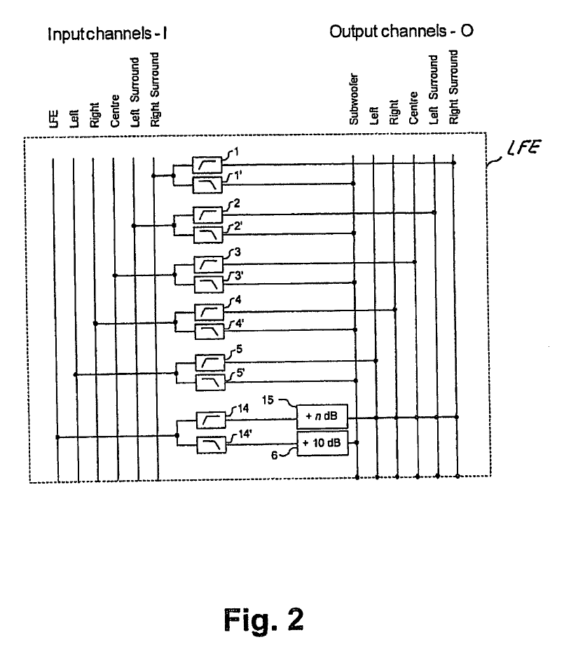

Referring to FIG. 2, there is shown a system according to the invention corresponding to the prior art system shown in FIG. 1. The crossover networks 1, 1′; 2, 2′; 3, 3′; 4, 4′; 5, 5′ dedicated to each of the five main channels will have the same characteristics as those for the implementation shown in FIG. 1. However, contrary to the prior art system, the crossover network 14, 14′ in the LFE channel is designed based on the upper-frequency limitations of the subwoofer.

Since, in this example, the upper band of the LFE channel is being produced by five loudspeakers instead of one, a reduction of the output level is required relative to the signal that would normally be sent to the subwoofer. In cases where the five main loudspeakers have matched characteristics, this gain value n (dB) may be calculated using the following equation:

n(dB)=C(dB)−x*log₂(m)(dB)

where n is the gain (in dB) applied to the signal as shown in FIG. 2, x is a value ranging between 3 dB and 6 dB, that is dependent both on frequency and placement of the main loudspeakers, that can be simplified to 4.5 dB, and m is the number of matched loudspeakers, and C is a user-defined gain trim value.

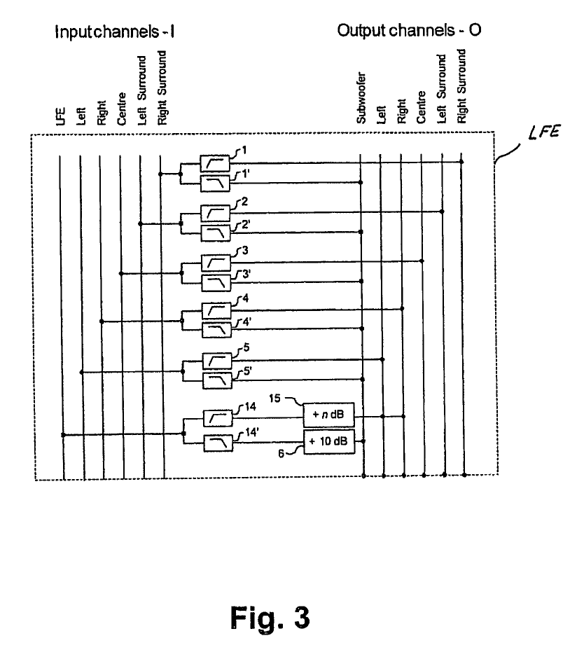

Referring to FIG. 3, there is shown a more typical domestic reproduction system consisting of two large loudspeakers for the left and right front channels and smaller loudspeakers for the centre and surround channels.

FIG. 3 shows a possible implementation of the proposed system in such a configuration. Note that—in this case—the upper frequency band of the LFE channel is produced only by the left front and right front loudspeakers instead of by all five loudspeakers.

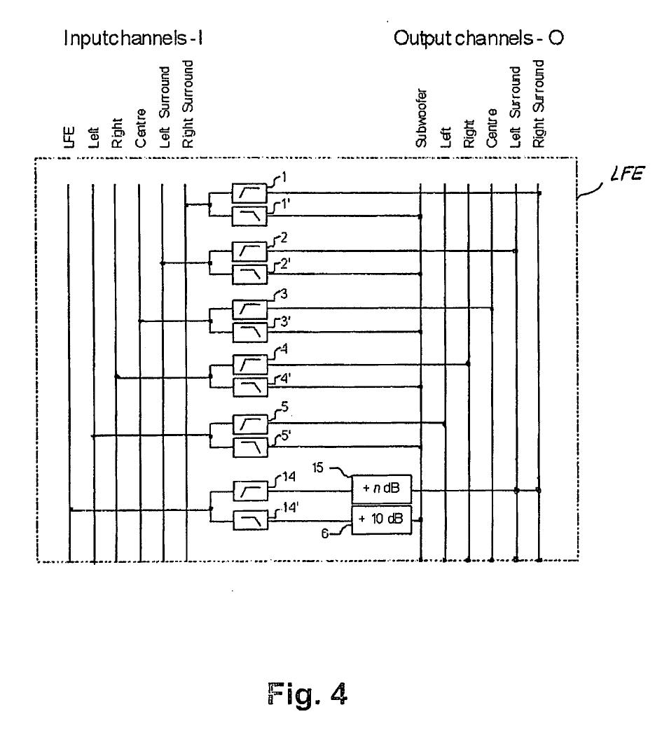

Referring to FIG. 4, there is shown an alternative embodiment of the LFE management system according to the Invention. In this embodiment, the upper frequency band of the LFE channel is, after appropriate scaling, provided to the left and right surround channels for reproduction by the surround loudspeakers. This solution could prove beneficial in some cases where relatively small front loudspeakers are required, whereas the surround loudspeakers, often located behind the listening positions, may be imposed to less severe limitations regarding their physical dimensions than the front loudspeakers.

1. A method for the reproduction of sound signals of a low frequency effect (LFE) channel in a loudspeaker system comprising at least one main loudspeaker and at least one low frequency subwoofer, where a second frequency region of the sound signals contained in the LFE channel above a given upper cut-off frequency is reproduced by at least one of said main loudspeakers characterized in that a first frequency region of the sound signals contained in the LFE channel below a given upper cut-off frequency is reproduced by the subwoofer, where said upper cutoff frequency is based on the upper frequency limitations of the subwoofer.

2. A method according to claim 1, characterized in that frequency components in said first frequency region are amplified by a first quantity (A) prior to provision to the subwoofer, and in that frequency components in said second frequency region are amplified by a second quantity (n) prior to provision of at least one main loudspeaker.

3. A method according to claim 2, characterized in that n is given by the equation:
n(dB)=C(dB)−x*log₂(m)(dB)
where n is the gain (in dB) applied to the signal, x is a value ranging between 3 dB and 6 dB, that is dependent on frequency and placement of the main loudspeakers, m is the number of matched loudspeakers, and C is a user-defined gain trim value.

4. A method according to claim 2, characterized in that said first quantity (A) is approximately 10 dB.

5. A method according to claim 1, characterized in that said upper cut-off frequency is determined according to the bandwidth of the subwoofer.

6. A method according to claim 1, characterized in that the said second frequency region is fed to all five main loudspeakers.

7. A method according to claim 1, characterized in that the said second frequency region is fed to a subset of the main loudspeakers.

8. A system for the reproduction of sound signals of a low frequency effect (LFE) channel in a loudspeaker system comprising at least one main loudspeaker and at least one low frequency subwoofer, characterized in that the system is provided with filter means for subdividing the frequency content of the LFE channel into a first frequency region below a given upper cut-off frequency and a second frequency region above this upper cut-off frequency, and in that the system further provides said first frequency region to the subwoofer(s) and said second frequency region to at least one of said main loudspeakers, where said upper cut-off frequency is based on the upper frequency limitations of the subwoofer.

9. A system according to claim 8, characterized in that the system is provided with means for adjusting the level of the frequency components in said first frequency region by a first quantity (A) prior to provision to the subwoofer(s) and means for adjusting the level of the frequency components in said second frequency region by a second quantity (n) prior to provision of the at least one main loudspeaker.

10. A system according to claim 9, characterized in that n is given by the equation:
n(dB)=C(dB)−x*log₂(m)(dB)
where n is the gain (in dB) applied to the signal, x is a value ranging between 3 dB and 6 dB, that is dependent on frequency and placement of the main loudspeakers, m is the number of matched loudspeakers, and C is a user-defined gain trim value.

11. A system according to claim 9, characterized in that said first quantity (A) is approximately 10 dB.

12. A system according to claim 8, characterized in that the said second frequency region provided by said filter means is fed to all five main loudspeakers.

13. A system according to claim 8, characterized in that the said second frequency region provided by said filter means is fed to a subset of the main loudspeakers.
